(19) United States
(12) Patent Application Publication
(10) Pub. No.: US 2011/0179856 A1
(43) Pub. Date: Jul. 28, 2011

(54) ANALYZING DEVICE

(75) Inventors: Takafumi Aono, Kyoto-shi (JP); Takeshi Takagi, Kyoto-shi (JP)

(73) Assignee: ARKRAY, INC., Kyoto-shi, Kyoto (JP)

(21) Appl. No.: 13/121,878

(22) PCT Filed: Oct. 2, 2009
(86) PCT No.: PCT/JP2009/067218

§ 371 Date: Mar. 30, 2011

(30) Foreign Application Priority Data
Oct. 6, 2008 (JP) 2008-259456

(51) Int. Cl. G01N 30/38

(52) U.S. Cl. 73/61.56

(57) ABSTRACT

A liquid chromatography device includes a column containing a filler, an injection valve capable of introducing a sample into the column and also capable of introducing a liquid mobile phase into the column, and a mobile phase feeder for feeding the liquid mobile phase from a mobile phase container containing the liquid mobile phase to the column via the injection valve. Between the mobile phase container and the injection valve is provided a storage chamber for temporarily storing the liquid mobile phase sent from the mobile phase container. The device further includes a liquid level detection sensor for detecting the liquid level of the liquid mobile phase in the storage chamber. This structure allows the liquid for use in analysis to be used completely without being wasted.

### INCORPORATION BY REFERENCE

This application is a 371 of International Application No. PCT/JP2009/067218 filed Oct. 2, 2009, which claims priority to Japanese Patent Application No. 2008-259456 filed Oct. 6, 2008, the entire contents of which being hereby incorporated herein by reference.

### TECHNICAL FIELD

The present invention relates to an analyzing device used as an analysis means in the field of biochemistry, medicine and the like.

### BACKGROUND ART

In recent years, liquid chromatography devices are often used for sample analysis in the field of organic chemistry, biochemistry, medicine or the like. An example of a liquid chromatography device is disclosed in e.g. Patent Document 1. FIG. 4 of the present application shows an example of the structure of a typical liquid chromatography device. The liquid chromatography device X shown in the figure includes a column 91, a detector 92, a liquid feed pump 93, an injection valve 94, a sample suction nozzle 95 and a suction unit 96. The liquid feed pump 93 is connected to a mobile phase container B containing a mobile phase such as an eluant. By actuating the liquid feed pump 93, the eluant is fed to the column 91 via the injection valve 94. The sample suction nozzle 95 is provided for drawing out the sample contained in a sample container C. The sample suction nozzle 95 is movable vertically or horizontally to successively draw out the sample contained in different sample containers C. The suction unit 96 is used to suck the sample into the injection valve 94.

To perform analysis using the liquid chromatography device X, the sample drawn into the injection valve 94 is first introduced into the column 91 for allowing the sample to be adsorbed to the filler in the column 91. Then, the eluant in the mobile phase container B is fed into the column 91 by using the liquid feed pump 93, whereby measurement by the detector 92 is performed. The sample adsorbed to the filler is desorbed by the eluant and separated into components in the column 91. The detector 92 detects each separated component by e.g. measuring the absorbance. The introduction of the sample into the injection valve 94, introduction of the sample into the column 91 or introduction of the eluant into the column are performed properly by appropriately changing the flow passage in the injection valve 94. Thereafter, the sample suction nozzle 95 is moved for attachment to a next sample container C different from the previous sample container C, and the sample contained in this sample container C is drawn into the injection valve 94. Repeating this operation allows successive analysis of samples from different sample containers C.

In this type of liquid chromatography device X for sample analysis, the mobile phase container B for containing an eluant is designed to have a relatively large volume to achieve successive analysis of a number of samples. When the eluant in the mobile phase container B is emptied out, gas enters the column 91, which hinders proper sample analysis and may further cause a failure of the device. To prevent such a problem, a liquid level detection sensor or the like is provided so that when the remaining amount of the eluant falls below a predetermined amount, the sensor detects it and the container is replaced with a new mobile phase container B full of eluant. The used mobile phase container B is disposed of.

In the above-described conventional structure, however, in replacing the mobile phase container B, the eluant remaining in the mobile phase container B is disposed of together with the container, being wasted. When the volume of the mobile phase container B is large, it follows that a large amount of unused eluant is disposed of, which is not desirable.
Patent Document 1: JP-A-H10-96715

### DISCLOSURE OF THE INVENTION

### Problems to be Solved by the Invention

The present invention has been proposed under the circumstances described above. It is therefore an object of the present invention to provide an analyzing device that allows a liquid for use in analysis to be used completely without being wasted.

### Means for Solving the Problem

According to a first aspect of the present invention, there is provided an analyzing device comprising a feeder for feeding a liquid for use in analysis from a container containing the liquid, a storage chamber for temporarily storing the liquid from the container, and a liquid level detector for detecting the level of the liquid in the storage chamber.

In a preferred embodiment of the present invention, the analyzing device is a liquid chromatography device comprising a column containing a filler, and an injection valve capable of introducing a sample into the column and also capable of introducing a liquid mobile phase as the liquid into the column. The storage chamber is provided between the container and the injection valve. The feeder feeds the liquid mobile phase in the container to the column via the injection valve.

In a preferred embodiment of the present invention, the feeder comprises a gas transfer pump connected to an upper portion of the storage chamber for discharging the gas in the storage chamber to the outside to reduce the pressure in the storage chamber to allow the liquid mobile phase in the container to be introduced into the storage chamber; and a liquid feed pump for feeding the liquid mobile phase in the container to the injection valve via the storage chamber, the liquid feed pump being provided between the storage chamber and the injection valve.

In a preferred embodiment of the present invention, the analyzing device further comprises a controller that actuates the gas transfer pump when the position of the liquid level detected by the liquid level detector is lower than a predetermined height and stops actuating the gas transfer pump when the position of the liquid level exceeds the predetermined height.

In a preferred embodiment of the present invention, the container or the storage chamber is provided with a check valve that allows outside air to enter when the inside of the storage chamber reaches a predetermined negative pressure.

In a preferred embodiment of the present invention, the storage chamber is provided with a discharge pipe for discharging the liquid mobile phase in the storage chamber toward the injection valve. The discharge pipe includes an end that opens sideways within the storage chamber.

Other features and advantages of the present invention will become more apparent from the detailed description given below with reference to the accompanying drawings.

### BRIEF DESCRIPTION OF THE DRAWINGS

FIG. 1 is a schematic structural view of a liquid chromatography device as an embodiment of an analyzing device according to the present invention;

FIG. 2 is a schematic structural view showing the state of feeding a sample into a column of the liquid chromatography device of FIG. 1;

FIG. 3 is a longitudinal sectional view of the schematic structure of a storage chamber; and

FIG. 4 is a schematic structural view of an example of conventional liquid chromatography device.

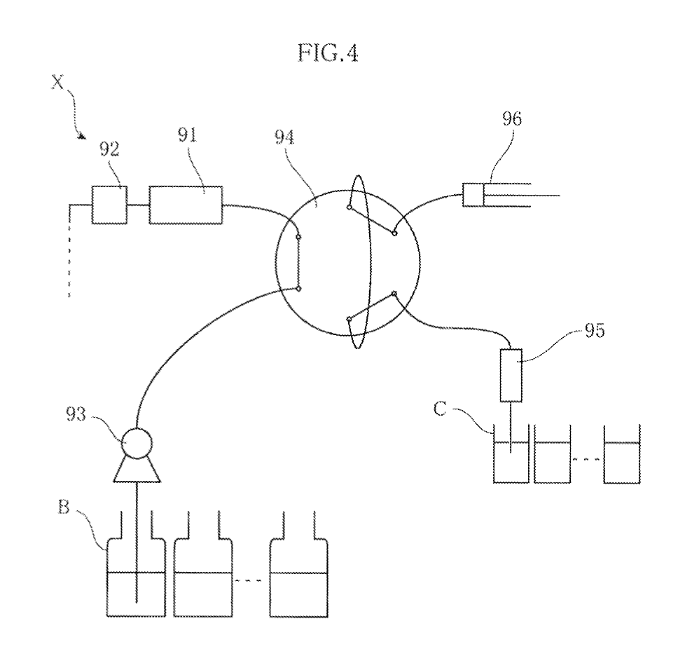

### BEST MODE FOR CARRYING OUT THE INVENTION

Preferred embodiments of the present invention are described below with reference to the accompanying drawings.

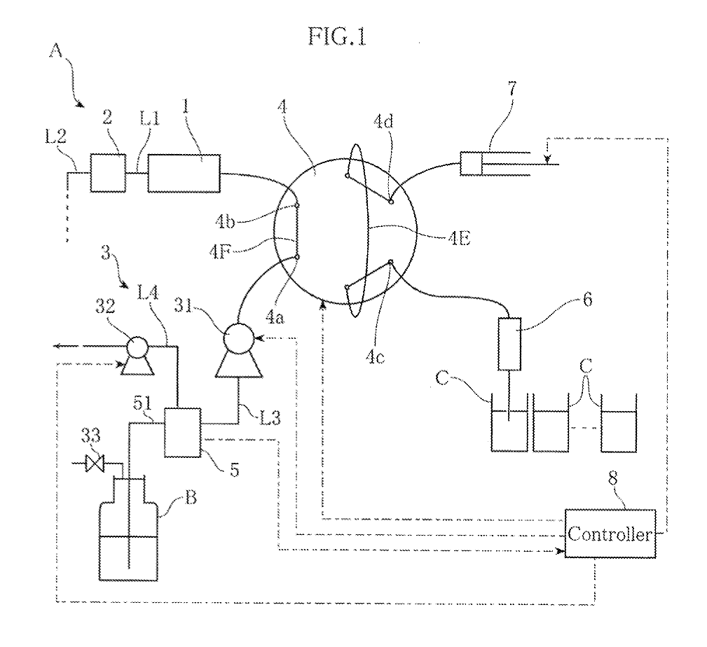

FIG. 1 is a schematic structural view of an analyzing device according to the present invention exemplarily structured as a liquid chromatography device. The liquid chromatography device A separates a sample supplied from a sample container C into components for analysis, by using an eluant as a mobile phase supplied from a mobile phase container B. The liquid chromatography device includes a column 1, a detector 2, a mobile phase feeder 3, an injection valve 4, a storage chamber 5, a sample suction nozzle 6, a suction unit 7, piping connecting these parts, and a controller 8.

The column 1 contains filler for adsorbing a sample introduced in the column and serves to control the adsorption/desorption of biological components relative to the filler and supply different kinds of biological components to the detector 2. When the eluant is introduced into the column 1 after the sample is adsorbed to the filler, the adsorbed sample is desorbed by the eluant. The desorbed sample and the eluant are discharged from the column 1 as an effluent and introduced into the detector 2 through a pipe L1.

The detector 2 measures the absorbance of the effluent from the column 1 to analyze the components of the sample. After passing through the detector 2, the effluent is discharged through a pipe L2 and collected in e.g. a liquid waste tank, not shown.

The mobile phase feeder 3 is provided for feeding the eluant in the mobile phase container B to the column 1 via the storage chamber 5 and the injection valve 4, and includes a liquid feed pump 31 and a gas transfer pump 32. The liquid feed pump 31 applies power for moving the eluant in the mobile phase container B to the injection valve 4 via the storage chamber 5. The liquid feed pump is provided at the pipe L3 connecting the storage chamber 5 and the injection valve 4. When the liquid feed pump 31 is actuated, the eluant in the storage chamber 5 is fed to the injection valve 4. The liquid feed pump 31 is also used for feeding the sample in the injection valve 4 to the column 1.

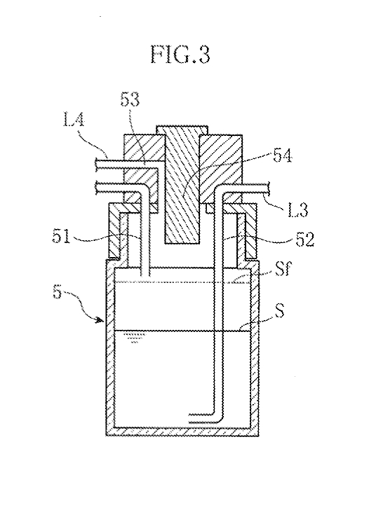

The gas transfer pump 32 discharges the gas in the storage chamber 5 to the outside to allow the eluant in the mobile phase container B to move into the storage chamber 5. The gas transfer pump is provided at a pipe L9. The pipe L4 has an end that is open to the outside and another end connected to an exhaust passage 53 of the storage chamber 5 (see FIG. 3), which will be described later.

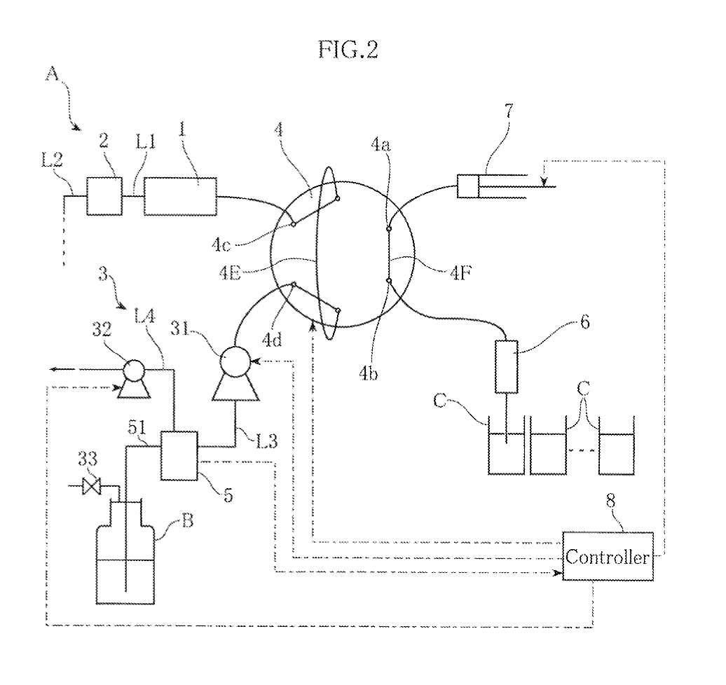

The injection valve 4 serves to introduce a predetermined amount of sample, fed to the injection valve, into the column 1 and also introduce the eluant from the storage chamber 5 into the column 1. The injection valve 74 comprises e.g. a six-way valve and includes ports 4a, 4b, 4c and 4d. The ports 4c and 4d are connected by a loop-like passage 4E that is capable of retaining a predetermined amount (e.g. 14 μm) of sample necessary for measurement. The injection valve 4 is designed to be able to change the connection target of the ports 4a, 4b, 4c and 4d. To feed the sample retained in the passage 4E to the column 1, as shown in FIG. 2, the port 4d is connected to the liquid feed pump 31, whereas the port 9c is connected to the column 1. When the liquid feed pump 31 is actuated in this state, the sample between the ports 4c and 4d is fed to the column 1. To feed the eluant to the column 1, the port 4a is connected to the liquid feed pump 31, whereas the port 4b is connected to the column 1. When the liquid feed pump 31 is actuated in this state, the eluant flows into the column 1 through the passage 4F between the ports 4a and 4b.

The storage chamber 5 is provided for temporarily storing the eluant fed from the mobile phase container B. The storage chamber comprises e.g. a hermetically closed container made of a chemical-resistant material such as glass or synthetic resin. The storage chamber 5 is provided with an eluant introduction pipe 51, an eluant discharge pipe 52, an exhaust passage 53 and a liquid level detection sensor 54. In this embodiment, while the volume of the mobile phase container B is about 1 L and the amount of the eluant used for a single time of analysis is about 2 mL, the volume of the storage chamber 5 is about 30 mL.

The eluant introduction pipe 51 is a pipe for introducing the eluant from the mobile phase container B into the storage chamber 5 and has an end that opens downward in an upper portion in the storage chamber 5. The eluant discharge pipe 52 is a pipe for discharging the eluant in the storage chamber 5 toward the injection valve 4, and is connected to the pipe L3 in an upper portion of the storage chamber 5. The eluant discharge pipe 52 includes a bent portion adjacent to the lower end, and the bent portion includes an end that opens sideways near the bottom of the storage chamber 5. The exhaust passage 53 is a passage for discharging the gas in the storage chamber 5 to the outside, and is connected to the pipe L4 at an upper portion of the storage chamber 5.

The liquid level detection sensor 54 comprises e.g. an optical sensor such as a photosensor and detects the position of the liquid level S of the eluant in the storage chamber 5.

In this embodiment, when the liquid level S reaches a full liquid level position Sf, which is a position reached when the chamber is full of liquid, the liquid level detection sensor 54 outputs a full liquid detection signal. The liquid level detection sensor 54 is not limited to a sensor that outputs what is called ON/OFF signals to indicate whether or not the position of the liquid level S is higher than a predetermined level, but may be e.g. a sensor that is capable of continuously detecting the position of the liquid level S relative to the liquid level detection sensor 54.

The mobile phase container B may comprise an aluminum package of a non-fixed shape or a plastic container of a fixed shape. In this embodiment, an aluminum package is suitably employed. An eluant is loaded in the mobile phase container B. The mobile phase container B is provided with a check valve 33 for allowing outside air to enter when the internal pressure reaches a predetermined negative pressure.

The sample suction nozzle 6 is provided for drawing the sample contained in the sample container C. In the sample container C, a sample such as blood of a human body is contained. The sample suction nozzle 6 is movable vertically or horizontally to successively draw the sample in different sample containers C.

The suction unit 7 is used to suck the sample into the injection valve 4.

The controller 8 controls the operation of each part of the liquid chromatography device A. The process of introducing the sample and the eluant into the column 1 under control by the controller 8 is described below. First, as shown in FIG. 1, the controller 8 causes the suction unit 7 to draw the sample from a first sample container C into the passage 4E of the injection valve 4 via the sample suction nozzle 6. By this operation, a predetermined amount of sample is introduced into the passage 4E.

Then, as shown in FIG. 2, the controller 8 rotates the injection valve 4 so that the port 4c is connected to the column 1 and the port 4d is connected to the liquid feed pump 31. Then, the controller 8 controls the liquid feed pump 31 so that the sample in the passage 4E between the ports 4c and 4d is fed into the column 1. Thus, the sample is introduced into the column 1 and adsorbed to the filler. Then, the controller 8 rotates the injection valve 4 so that the port 4a is connected to the liquid feed pump 31 and the port 4b is connected to the column 1. The controller 8 then controls the liquid feed pump 31 so that the eluant is fed from the storage chamber 5 into the column 1. The eluant fed into the column 1 desorbs the sample from the filler, whereby an effluent is produced. The effluent is subjected to measurement by the detector 2, whereby the result of the first time of analysis is obtained.

Then, the controller 8 moves the sample suction nozzle 6 to attach the sample suction nozzle 6 to a second sample container C. Thereafter, the liquid feed pump 31 and the injection valve 4 are controlled in the same manner as in the first time of analysis, whereby the result of the second time of analysis is obtained. By repeating the same control, the third and the subsequent analysis are successively performed.

The controller 8 also controls the operation of the gas transfer pump 32 to introduce the eluant in the mobile phase container B into the storage chamber 5. Specifically, the controller 8 performs control based on the information on the position of the liquid level S of the eluant in the storage chamber 5 detected by the liquid level detection sensor 54. When the gas transfer pump 32 is actuated, the gas in the storage chamber 5 is discharged to the outside via the exhaust passage 53 and the pipe L4, whereby the pressure in the storage chamber 5 drops. Thus, the eluant in the mobile phase container B is introduced into the storage chamber 5 via the eluant introduction pipe 51.

Herein, the controller 8 actuates the gas transfer pump 32 when the position of the liquid level S detected by the liquid level detection sensor 54 is lower than the predetermined height, i.e., the full liquid level position Sf. When the liquid level S reaches the full liquid level position Sf, the controller 8 stops actuating the gas transfer pump 32 in accordance with the full liquid detection signal from the liquid level detection sensor 54. These operations keep the amount of the eluant in the storage chamber 5 substantially constant.

The advantages of the liquid chromatography device A are described below.

In the liquid chromatography device A having the above-described structure, the storage chamber 5 is provided between the mobile phase container B and the injection valve 4. As the sample analysis proceeds, the eluant in the storage chamber 5 is consumed, and the eluant in the mobile phase container B is consumed accordingly. By successively performing analysis with respect to a number of samples, the eluant in the mobile phase container B is eventually emptied. At this point, however, the eluant still remains in the storage chamber 5. The remaining amount of the eluant in the storage chamber 5 is detected by the liquid level detection sensor 54. Thus, the mobile phase container B can be replaced with a new one when the remaining amount of eluant in the storage chamber 5 falls below a predetermined amount. This allows the mobile phase container B to be replaced after the eluant in the container is completely used, so that the eluant for the analysis is not wasted by the replacement. Moreover, the above-described structure allows a predetermined amount of eluant to constantly remain in the storage chamber 5. Thus, the sample analysis can be continued even during the replacement of the mobile phase container B, which is advantageous in terms of efficiency of the analysis work.

In the present embodiment, apart from the liquid feed pump 31 for feeding the eluant from the storage chamber 5, the gas transfer pump 32 for introducing the eluant in the mobile phase container B into the storage chamber 5 is provided. By actuating the gas transfer pump 32, the eluant in the mobile phase container B is efficiently and properly introduced into the storage chamber 5.

When the eluant in the storage chamber 5 is sent out by the actuation of the liquid feed pump 31, the controller 8 properly controls the gas transfer pump 32 to keep the amount of the eluant in the storage chamber 5 substantially constant. This contributes to stable supply of the eluant to the column 1.

Moreover, in the present embodiment, the mobile phase container B is provided with the check valve 33 that allows outside air to enter when the inside of the storage chamber 5 reaches a predetermined negative pressure. This prevents excessive negative pressure from being applied to the storage chamber 5 or the mobile phase container B when the eluant in the mobile phase container B is emptied. Thus, the eluant in the storage chamber 5 is smoothly supplied toward the injection valve 4. Thus, the eluant in the storage chamber 5 can be used almost completely without interruption. Moreover, by preventing generation of excessive negative pressure, it is possible to avoid problems such as the application of undesirable load on the connecting portion of a cap or the like in e.g. replacing the mobile phase container B. Further, the application of overload on the liquid feed pump 31 or the parts such as a solenoid valve arranged in the piping is also prevented.

In the present embodiment, the eluant discharge pipe 52 for discharging the eluant toward the injection valve 4 has an end that opens sideways. Thus, even when the dissolved gas in the eluant is turned into bubbles and diffused at the inner surface (bottom surface or side surface) of the storage chamber 5, the bubbles do not easily enter the eluant discharge pipe 52, which allows proper sample analysis.

The present invention is not limited to the foregoing embodiment. The specific structure of each part of the analyzing device according to the present invention may be varied in many ways. Although a liquid chromatography device is described in the foregoing embodiment as an example of the analyzing device of the present invention, the structure other than a liquid chromatography device can be employed as the analyzing device of the present invention.

1. An analyzing device comprising:
a feeder for feeding a liquid for use in analysis from a container containing the liquid;
a storage chamber for temporarily storing the liquid from the container; and
a liquid level detector for detecting a level of the liquid in the storage chamber.

2. The analyzing device according to clam 1, wherein the analyzing device is a liquid chromatography device comprising:
a column containing a filler; and
an injection valve capable of introducing a sample into the column and also capable of introducing a liquid mobile phase as the liquid into the column, wherein:
the storage chamber is provided between the container and the injection valve; and
the feeder feeds the liquid mobile phase in the container to the column via the injection valve.

3. The analyzing device according to clam 2, wherein the feeder comprises:
a gas transfer pump connected to an upper portion of the storage chamber for discharging gas in the storage chamber to outside to reduce pressure in the storage chamber to allow the liquid mobile phase in the container to be introduced into the storage chamber; and
a liquid feed pump for feeding the liquid mobile phase in the container to the injection valve via the storage chamber, the liquid feed pump being provided between the storage chamber and the injection valve.

4. The analyzing device according to clam 3, further comprising a controller that actuates the gas transfer pump when position of the liquid level detected by the liquid level detector is lower than a predetermined height and stops actuating the gas transfer pump when the position of the liquid level exceeds the predetermined height.

5. The analyzing device according to clam 3, wherein the container or the storage chamber is provided with a check valve that allows outside air to enter when inside of the storage chamber reaches a predetermined negative pressure.

6. The analyzing device according to clam 2, wherein the storage chamber is provided with a discharge pipe for discharging the liquid mobile phase in the storage chamber toward the injection valve, the discharge pipe including an end that opens sideways within the storage chamber.
